(19) United States
(12) Patent Application Publication
(10) Pub. No.: US 2010/0294896 A1
(43) Pub. Date: Nov. 25, 2010

(54) HOLDING DEVICE FOR MOUNTING PARTS INSTALLED INSIDE AN AIRCRAFT FUSELAGE

(75) Inventor: Cihangir SAYILGAN, Hamburg (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: Airbus Deutschland GmbH, Hamburg (DE)

(21) Appl. No.: 12/763,443

(22) Filed: Apr. 20, 2010

Related U.S. Application Data
(60) Provisional application No. 61/171,217, filed on Apr. 21, 2009.

(30) Foreign Application Priority Data
Apr. 21, 2009 (DE) 10-2009-017-977.1

(51) Int. Cl. F16L 3/08; F16M 13/02

(52) U.S. Cl. 248/73; 248/224.8

(57) ABSTRACT

A holding device for a mounting part installed inside an aircraft fuselage having a lining including an insulating mat, the holding device includes a fastening part attached to the aircraft fuselage and protruding through an opening in the insulating mat; a sealing disk; and a holding part configured to attach the mounting part and being disposed on an inner side of the aircraft fuselage and cooperating with the fastening part configured to attach the mounting part so as to simultaneously fix the insulating mat between the fastening part and the holding part, wherein the holding part extends through the opening in a sealed manner, and wherein a lower surface of the sealing disk contacts and seals an edge region of the opening when the holding part is installed on the fastening part.

Priority is claimed to German Application No. DE 10 2009 017 977.1, filed on Apr. 21, 2009 and to U.S. Provisional Application No. 61/171,217, filed on Apr. 21, 2009, the entire disclosure of both applications is incorporated by reference herein.

The present invention pertains to a holding device for mounting parts installed inside an aircraft fuselage that essentially consists of a fastening part for being attached to the aircraft fuselage that protrudes through an opening in an insulating mat forming at least a partial lining of the aircraft fuselage and cooperates with a holding part on the inner side of the aircraft fuselage in order to fasten the mounting part and to simultaneously fix the insulating mat.

The field of application of the present invention is related to the interior finishing of aircraft fuselages, in which holding devices are primarily used for fixing and guiding electric cable harnesses. In addition to this application, the interesting holding devices in this context can also serve for attaching conduits, for example, of the air-conditioning system. Mounting parts of this type are usually fastened stationarily, but separably relative to the aircraft fuselage, namely on an insulating mat that is arranged in between and at least partially lines the inside of the aircraft fuselage in order to protect the interior of the aircraft fuselage from external low-temperature or high-temperature influences.

### BACKGROUND

DE 10 2004 009 967 A1 discloses a holding device that is referred to as a cable holder and serves for attaching mounting parts in an aircraft fuselage. In order to create a flexible solution with respect to the type of mounting part, the holding device is designed in a multipart fashion. A base element features fastening means for being fastened on the aircraft fuselage while a cable holder module that can be inserted into the base element can be exchanged depending on the type of mounting part to be installed. The exchangeability is ensured by at least one pin that is integrally formed onto the cable holder module and can be inserted into a corresponding recess in the base element. In the inserted state, the cable holder module and the base element directly contact one another. The cable holder module can be exchanged in accordance with a modular principle depending on the mounting part to be installed.

The disadvantage of the known holding device is that it cannot be used in connection with insulating mats for lining the aircraft fuselage. At the locations, at which the aircraft fuselage is provided with insulating mats, electric cable harnesses and conduits extend above the insulating mats. This requires that the holding devices that are usually attached to suitable frames of the aircraft fuselage bridge the insulating mat.

DE 10 2005 045 846 A1 discloses another holding device that is suitable for use in connection with insulating mats. For this purpose, the holding device penetrates the insulating mat with a rod-shaped intermediate part in order to be fastened on a suitable frame of the aircraft fuselage. In this case, the rod-shaped intermediate part is provided with a disk-shaped flange that extends radially outward and prevents the insulating mat from sliding off the holding device. In the normal operating state, the insulating mat is reliably fixed relative to the aircraft fuselage by means of this flange. If the flange consisting of plastic melts in an emergency under the influence of a fire, a flat coil spring that expands as a consequence thereof takes over the function of the flange.

Although this technical solution makes it possible to realize an emergency-safe function of the flange, one disadvantage of the known solution can be seen in that condensation water can penetrate into the interior of the aircraft fuselage in the normal operating state through the opening provided in the insulating mat for the holding device. Although the flange prevents the insulating mat from sliding off the holding device, this positive connection does not prove to be sufficiently impervious.

### SUMMARY OF THE INVENTION

An aspect of the present invention is to develop a holding device for the installation of mounting parts in an aircraft fuselage that is suitable for simultaneously fixing insulating mats and, on the other hand, ensures a reliable seal against penetrating condensation water.

The invention includes the technical characteristic that the holding part of the holding device features a sealing disk in order to extend through the opening of an insulating mat in a sealed fashion, wherein the lower surface of said sealing disk comes in contact with and seals the edge region of the opening of the insulating mat during the installation of the holding part on the fastening part.

The advantage of the inventive solution can be seen, in particular, in that the entire cross section of the opening in the insulating mat can be sealed by means of this sealing disk. During the installation of the holding part on the fastening part fastened on the aircraft fuselage through the opening in the insulating mat, the required seal is simultaneously produced by means of the sealing disk. Condensation water can no longer penetrate from the inner wall of the aircraft fuselage into the interior of the aircraft fuselage through the opening in the insulating mat.

The holding part is preferably attached to the fastening part by means of a clip-on connection such that a particularly simple installation of the holding device can be achieved and the insulating mat is simultaneously fixed. Any separable or inseparable snap-fit connection known from the installation technology may, in principle, be used as suitable clip-on connection.

According to a measure that further improves the invention, it is proposed to equip the clip-on connection with additional positive guiding means for definitively positioning the holding part relative to the fastening part. This advantageously makes it possible to preclude an incorrect installation of the holding part relative to the fastening part such that the holding part always reaches the intended nominal position. In this case, non-circular cross sections may be used as positive guiding means.

The fastening part, the holding part and the sealing disk preferably consist of the same plastic material such as, for example, polyamide (PA) or polyetherketone (PEK). These plastic materials can be processed by means of injection moulding such that the aforementioned components can be easily manufactured.

According to a measure that improves the invention with respect to the attainable sealing effect, it is proposed that the sealing disk can be axially adjusted relative to the holding part by means of an incremental snap-fit connection in order to increase the sealing force after the installation of the holding part on the fastening part by incrementally pressing the sealing disk in the direction of the insulating mat. This makes it possible to take into account insulating mats with different thicknesses or different installation tolerances by simply pressing the sealing disk against the insulating mat manually.

The snap-fit connection preferably consists of at least one axial row of snap-in grooves that is arranged on the holding part or the fastening part and cooperates with a corresponding flexible tab on the sealing disk. It is particularly preferred that two rows of snap-in grooves are oppositely arranged on the outside of the fastening part of the holding device and cooperate with two flexible tabs that are also arranged oppositely on the edge of the recess of the sealing disk.

It is furthermore proposed to realize the sealing disk on the holding part, as well as the opening in the insulating mat, in a circular fashion so as to achieve an edge region that can be covered by the sealing disk as uniformly as possible. This ensures that the sealing disk produces a reliable seal around the entire opening in the insulating mat. The covered edge region should have a width of at least 5 mm in this case.

### BRIEF DESCRIPTION OF THE DRAWINGS

Other measures that improve the invention are discussed in greater detail below together with the description of one preferred exemplary embodiment of the invention with reference to the figures. In the drawings:

FIG. 1 shows a perspective exploded view of a holding device with insulating mat before the installation,

FIG. 2 shows a longitudinal section through the holding device of FIG. 1 after the installation,

FIG. 3 shows a perspective representation of a holding part with assigned sealing disk before the installation, and

FIG. 4 shows a perspective representation of the holding part of FIG. 3 with sealing disk after the installation.

### DETAILED DESCRIPTION

According to FIG. 1, the holding device essentially consists of a fastening part 1 that is separably fastened in the frame region 3 of a—not-shown—aircraft fuselage by means of a screw connection 2. The fastening part 1 carries a holding part 4 by means of a clip-on connection—that is described in greater detail below—and said holding part features a fork-like holder section 5 for fastening a—not-shown—mounting part on the side that lies opposite of the fastening part 1. The holding part 4 protrudes through an opening 6 in an insulating mat 7 that serves for lining the aircraft fuselage, wherein the lower surface of a sealing disk 8 that is pushed over the holding part 4 comes in contact with and seals the edge region of the opening 6 in the insulating mat 7 during the installation of the holding part 4 on the fastening part 1. The opening 6, as well as the sealing disk 8, has a circular cross section in this exemplary embodiment, wherein the sealing disk 8 has the relatively larger diameter in order to reliably fulfill the desired sealing function. The sealing disk 8 prevents condensation water from penetrating into the interior of the aircraft fuselage through the opening 6 in the insulating mat 7.

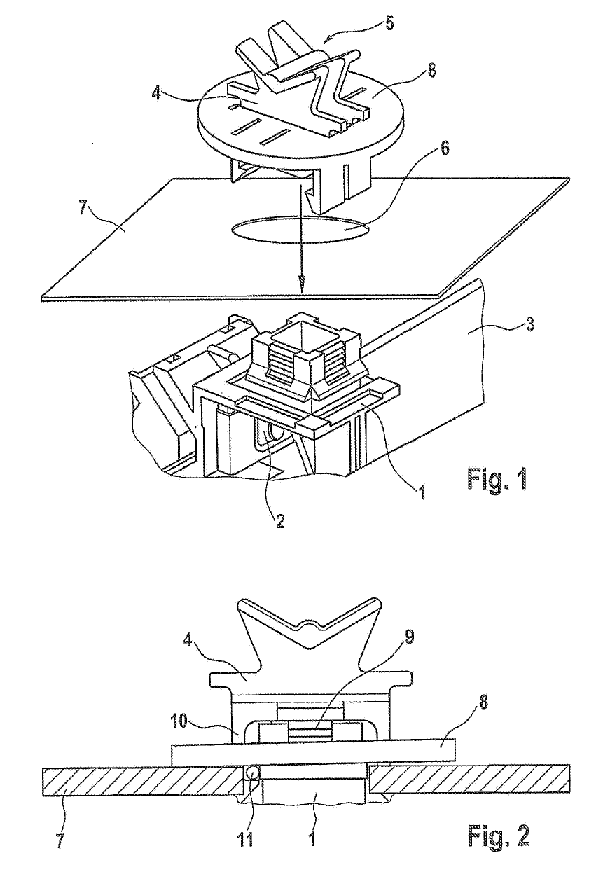

According to FIG. 2, the sealing disk 8 can be axially adjusted relative to the holding part 4 by means of a snap-fit connection. In this case, the snap-fit connection is produced by two axial rows of snap-in grooves 9—of which only one is visible in the figure—that are oppositely arranged on the outside of the fastening part 1 and cooperate with a corresponding spring of at least the sealing disk 8. The sealing force can be additionally increased after the installation of the holding part 4 on the fastening part 1 by pressing the sealing disk 8 in the direction of the insulating mat 7.

The clip-on connection between the holding part 4 and the fastening part 1 consists (for example) of a pair of oppositely arranged, hook-shaped flexible arms 10 that snap behind corresponding shoulders 11 integrally formed onto the fastening part 1.

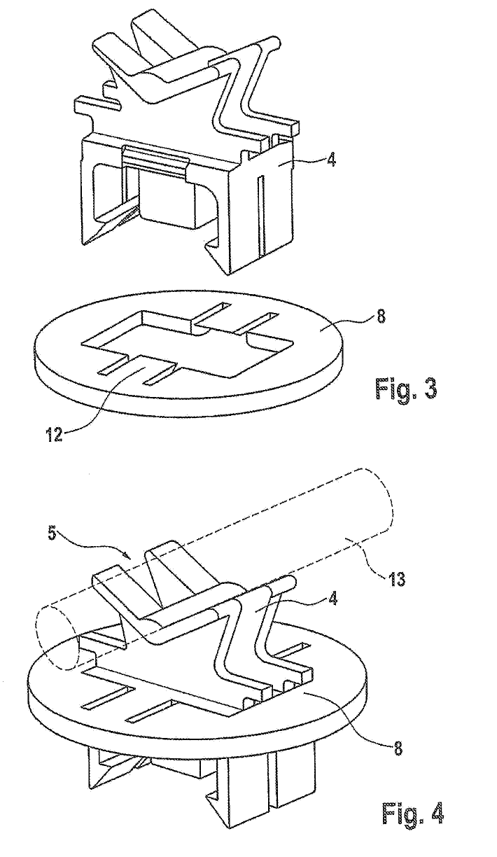

According to FIG. 3, the sealing disk 8 features two oppositely arranged flexible tabs 12 on its central opening for accommodating the holding part 4, wherein these flexible tabs form part of the above-described snap-fit connection together with the—not-shown—row of snap-in grooves of the fastening part 1.

FIG. 4 shows the installed position of the sealing disk 8 on the holding part 4 before attaching the holding part 4 to the—not-shown—fastening part 1 and simultaneously fixing the insulating mat 7.

A schematically illustrated mounting part 13 is separably fastened on the fork-like holder section 5 of the holding part 4 by means of cable ties. The mounting part 13 consists of a conduit in this exemplary embodiment.

The invention is not limited to the above-described preferred exemplary embodiment. In fact, it is also conceivable to realize variations of this preferred exemplary embodiment that fall under the scope of protection of the following claims. For example, it is also possible to fix a mounting part 13 in the form of an electric cable harness in the frame region 3 of the aircraft fuselage by means of the inventive holding device instead of a conduit. The opening 6 in the insulating mat 7 and the corresponding sealing disk 8 may also have a different cross-sectional or surface shape as long as a sufficiently wide edge region for effectively sealing the interior of the aircraft fuselage against penetrating condensation water is created between the two components.

As a supplement, it should be noted that “comprising” does not exclude other elements or steps, and that “an” or “a” does not exclude a plurality. It should furthermore be noted that characteristics or steps that were described with reference to one of the above exemplary embodiments can also be used in combination with other characteristics or steps of other above-described exemplary embodiments. Reference symbols in the claims should not be interpreted in a restrictive sense.

### LIST OF REFERENCE SYMBOLS

1 Fastening part
2 Screw connection
3 Frame region
4 Holding part
5 Holder section
6 Opening
7 Insulating mat
8 Sealing disk
9 Row of snap-in grooves
10 Flexible arm
11 Shoulder
12 Flexible tab
13 Mounting part

What is claimed is:

1. A holding device for a mounting part installed inside an aircraft fuselage having a lining including an insulating mat, the holding device comprising:
a fastening part attached to the aircraft fuselage and protruding through an opening in the insulating mat;
a sealing disk; and
a holding part configured to attach the mounting part and being disposed on an inner side of the aircraft fuselage and cooperating with the fastening part configured to attach the mounting part so as to simultaneously fix the insulating mat between the fastening part and the holding part, wherein the holding part extends through the opening in a sealed manner, and wherein a lower surface of the sealing disk contacts and seals an edge region of the opening when the holding part is installed on the fastening part.

2. The holding device as recited in claim 1, wherein the sealing disk is a part of the holding part.

3. The holding device as recited in claim 1, wherein the holding part cooperates with the fastening part via a clip-on connection.

4. The holding device as recited in claim 3, wherein the clip-on connection includes a positive guiding element configured to definitively position the holding part relative to the fastening part during the installation.

5. The holding device as recited in claim 1, wherein the holding part, the fastening part, and the sealing disk include the same injection molded-material.

6. The holding device as recited in claim 1, wherein the sealing disk is axially adjustable relative to the holding part via a snap-fit connection configured to increase a sealing effect after the installation of the holding part on the fastening part when the sealing disk is pressed in a direction of the insulating mat.

7. The holding device as recited in claim 6, wherein the snap-fit connection includes at least one axial row of snap-in grooves disposed on one of the holding part and the fastening part, wherein the at least one axial row of grooves is configured to cooperate with a corresponding flexible tab on the sealing disk.

8. The holding device as recited in claim 1, wherein the sealing disk and the opening are circular.

9. The holding device as recited in claim 8, wherein a portion of the edge region covered by the sealing disk has a width of at least 5 mm.

10. The holding device as recited in claim 1, wherein the fastening part is attached to a frame region of the aircraft fuselage via a screw connection.

11. The holding device as recited in claim 1, wherein the holding part includes a fork-like holder section facing away from the fastening part and configured to fasten the mounting part.

12. The holding device as recited in claim 11, wherein the mounting part is detachably fastened on the fork-like holder section via cable ties.

13. The holding device as recited in claim 1 wherein the mounting part is one of an electrical cable harness and conduit.
